(19) United States
(12) Patent Application Publication
(10) Pub. No.: US 2017/0171644 A1
(43) Pub. Date: Jun. 15, 2017

(54) Method and electronic device for creating video image hyperlink

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Xuan LIU, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/241,854

(22) Filed: Aug. 19, 2016

Related U.S. Application Data
(63) Continuation of application No. PCT/CN2016/089527, filed on Jul. 10, 2016.

(30) Foreign Application Priority Data
Dec. 14, 2015 (CN) 201510924523.X

(51) Int. Cl. H04N 21/858; H04N 21/234; H04N 21/45; H04N 21/854; G06K 9/00; H04N 21/258

(52) U.S. Cl. CPC H04N 21/858; G06K 9/00718; H04N 21/25891; H04N 21/4532; H04N 21/85406; H04N 21/23418

(57) ABSTRACT

In the field of video image technologies, a method and electronic device for creating a video image hyperlink are provided. The method includes: acquiring at least one frame in a stored video; performing image processing on the at least one frame to extract information of a user's interest in the at least one frame; obtaining, according to the information of a user's interest in the at least one frame, a hyperlink that corresponds to the information of a user's interest in the at least one frame; and adding the information of a user's interest in the at least one frame and the corresponding hyperlink to a video play page.

The present disclosure claims priority to Chinese Patent Application No. 201510924523.X, filed with the Chinese Patent Office on Dec. 14, 2015, which is incorporated herein by reference in its entirety

### TECHNICAL FIELD

The present disclosure relates to the field of video image technologies, and in particular, to a method and a server for creating a video image hyperlink.

### BACKGROUND

A video includes a large amount of information, for example, weather, traffic, location, or character's clothing, etc., and after watching the video, a user expects to further learn about some interesting information therein. For example, the user wants to know these information relevant to an image in the video, for example, a brand of a backpack and its price of a leading character in a television drama, or introduction of a location that occurs in the television drama, etc.

In prior art, when the user wants to learn about the foregoing content (that is, information that the user is interested in) in a video, the user generally needs to by herself/himself search or comment on a search page, or post a message in a post bar to look for information that the user wants to know. Therefore, prior art lacks a method capable of creating a link for information of a user's interest occurring in a video.

### SUMMARY

With respect to the technical problem that prior art lacks a method capable of creating a link for information of a user's interest occurring in a video, some embodiments of the present disclosure provide a method for creating a video image hyperlink, where the method includes: acquiring at least one frame in a stored video; performing image processing on the at least one frame to extract information of a user's interest in the at least one frame; obtaining, according to the information of a user's interest in the at least one frame, a hyperlink that corresponds to the information of a user's interest in the at least one frame; and adding the information of a user's interest in the at least one frame and the corresponding hyperlink to a video play page.

Correspondingly, some embodiments of the present disclosure further provide a server, where the server includes: a frame acquiring module configured to acquire at least one frame in a stored video; an image processing module configured to perform image processing on the at least one frame to extract information of a user's interest in the at least one frame; a hyperlink obtaining module configured to obtain, according to the information of a user's interest in the at least one frame, a hyperlink that corresponds to the information of a user's interest in the at least one frame; and a hyperlink adding module configured to add the information of a user's interest in the at least one frame and the corresponding hyperlink to a video play page.

The method and a server for creating a video image hyperlink provided in some embodiments of the present disclosure, enable a hyperlink to be created for information of a user's interest occurring in a video by first acquiring at least one frame in a stored video, subsequently performing image processing on the at least one frame to extract information of a user's interest in the at least one frame, next obtaining, according to the information of a user's interest in the at least one frame, a hyperlink that corresponds to the information of a user's interest in the at least one frame, and finally adding the information of a user's interest in the at least one frame and the corresponding hyperlink to a video play page. Namely, the information of a user's interest occurring in a video and the corresponding hyperlink will occur on a video play page, so that a user can conveniently and quickly enter a page relevant to the information of the user's interest (for example, an introduction page or a purchase page of the information of the user's interest) by clicking the hyperlink to learn more, thereby greatly improving user experience and satisfying a user's requirement.

Other characteristics and advantages of some embodiments of the present disclosure are described in detail in a subsequent part of DETAILED DESCRIPTION.

### BRIEF DESCRIPTION OF THE DRAWINGS

The accompanying drawings are used to provide further understanding of some embodiments of the present disclosure and form a part of the specification. The accompanying drawings are used to explain some embodiments of the present disclosure together with the following specific implementation manners, but do not constitute a limitation to the present disclosure. In the accompanying drawings:

FIG. 1 is a schematic structural diagram of a server according to an implementation manner of the present disclosure; and

FIG. 2 is an exemplary flowchart of a method for creating a video image hyperlink according to an implementation manner of the present disclosure.

### DESCRIPTION OF REFERENCE NUMBERS

Frame acquiring module 20 Image processing module

30 Hyperlink obtaining module 40 Hyperlink adding module

100 Server

### DETAILED DESCRIPTION

The following describes specific implementation manners of the present disclosure in detail with reference to the accompanying drawings. It should be understood that the specific implementation manners described herein are merely used for describing and explaining the present disclosure, and are not used to limit the present disclosure.

The following describes the concept of the present disclosure by examples, but it should be understood that these examples are non-limitative examples, and are not intended to limit the protection scope of the present disclosure.

To describe the concept of the present disclosure more clearly, description is provided in detail by using a process of an exemplary server 100 for creating a video image hyperlink as an example.

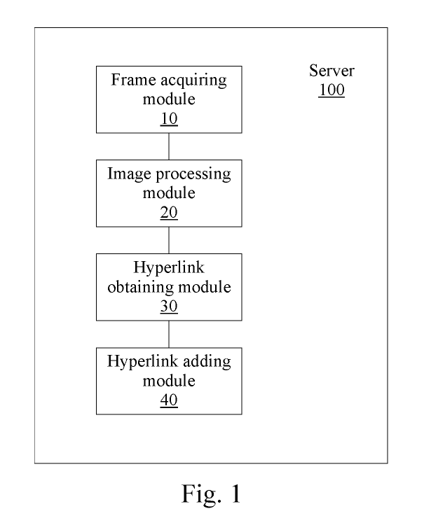

FIG. 1 is a schematic structural diagram of a server according to an implementation manner of the present disclosure. As shown in FIG. 1, the server may include: a frame acquiring module 10 configured to acquire at least one frame in a stored video; an image processing module 20 configured to perform image processing on the at least one frame to extract information of a user's interest in the at least one frame; a hyperlink obtaining module 30 configured to obtain, according to the information of a user's interest in the at least one frame, a hyperlink that corresponds to the information of a user's interest in the at least one frame; and a hyperlink adding module 40 configured to add the information of a user's interest in the at least one frame and the corresponding hyperlink to a video play page.

Such an implementation manner enables information of a user's interest occurring in a video and a corresponding hyperlink to occur on a video play page, so that a user can conveniently and quickly enter a page relevant to the information of the user's interest (for example, an introduction page or a purchase page of the information of the user's interest) by clicking the hyperlink (for example, clicking a hyperlink on a video play page displayed on a video application program of a smart phone) to learn more, thereby greatly improving user experience and satisfying a user's requirement.

In this embodiment, because a video file is a basis for extracting the information of a user's interest, a server may further include a video storage module (not shown), where the video storage module is configured to store a video in a file format of m3u8. An advantage of storing the video file in the file format of m3u8 lies in, by dividing the video file into multiple segments with a short duration, enabling a terminal to select and switch bit rates quickly, so as to adapt to play under conditions of different bandwidths.

Specifically, in a video, the information of a user's interest comprises at least one of an article brand, an article price, an article name, an article introduction, a location name, a location introduction, a character name, and a personage introduction. Therefore, the frame acquiring module 10 of a server 100 first can acquire at least one frame in the video stored in the video storage module, where the at least one frame is one or more frame images. In a video, a frame A showing a book, a frame B showing a character, a frame C showing a scenic spot, and the like, these information may be information of a user's interest. Therefore, image processing can be performed on these image information to extract the information and create a hyperlink. For example, the frame acquiring module 10 can acquire the at least one frame in the video by means of an open graphics library (OpenGL); for example, at least one of the frames A, B, and C can be acquired from the video by means of the OpenGL.

Next, the image processing module 20 can perform image processing on the at least one frame to extract the information of a user's interest in the at least one frame. For example, the image processing module may include: a region-of-interest (ROI) extraction unit, a preprocessing unit, and a feature extraction unit. The ROI extraction unit can perform ROI extraction on the at least one frame to reduce complexity and runtime of image processing, and reduce unnecessary noise interference. For example, by using block selection (for example, a rectangular frame, etc.) or contour selection, a book shown in the frame A, a character shown in the frame B, and a scenic spot shown in the frame C can be extracted, and an image other than that of the information of a user's interest can be removed. Subsequently, the preprocessing unit can perform gray processing on an image in the extracted ROI. Next, the feature extraction unit can perform feature extraction on the gray processed image to extract the information of a user's interest in the at least one frame. A specific feature extraction process may include edge detection such as Roberts operator, Sobel operator, Prewitt operator or the like, Hough transform, threshold segmentation, and the like. Preferably, the foregoing feature extraction function of the image processing module 20 can also be implemented by the OpenGL.

Next, the hyperlink obtaining module 30 of the server 100 can receive the information of a user's interest in the at least one frame extracted by the image processing module 20, and obtain, according to the information of a user's interest in the at least one frame, a hyperlink that corresponds to the information of a user's interest in the at least one frame. For example, a hyperlink of an introduction page or a purchase page of the book extracted from the frame A, an introduction page or an official fans page of the character (for example, a famous star) extracted from the frame B, and an introduction page or an official page of the scenic spot extracted from the frame C are obtained. Next, the hyperlink adding module 40 of the server 100 can add the information of a user's interest in the at least one frame and the corresponding hyperlink to a video play page. For example, a book name (for example, “book name XX”) of the book extracted from the frame A is added to a region of the video play page, a name (for example, “star XX”) of the character extracted from the frame B is added to a region of the video play page, and a name (for example, “location XX”) of the scenic spot extracted from the frame C is added to a region of the video play page. In this way, when the server 100 pushes the video play page to a terminal used by a user, the user, when or after watching the video, can click the information of the user's interest listed in a specific region on the video play page, so as to be hyperlinked to a page relevant to the information, thereby further learning about the information.

It should be understood that, in the foregoing embodiment, a description is provided by using extracting only one piece of information of a user's interest (for example, a book shown in the frame A, a character shown in the frame B, or a scenic spot shown in the frame C) from one frame of a video as an example. However, actually, multiple pieces of information of a user's interest (for example, a book, a character, and a scenic spot shown in the frame A) can also be extracted from one frame. Such exemplary processes of information acquisition, image processing, and hyperlink obtaining and adding are similar to those in the foregoing implementation manner; that is, the concept of the present disclosure is not limited to the foregoing implementation manner.

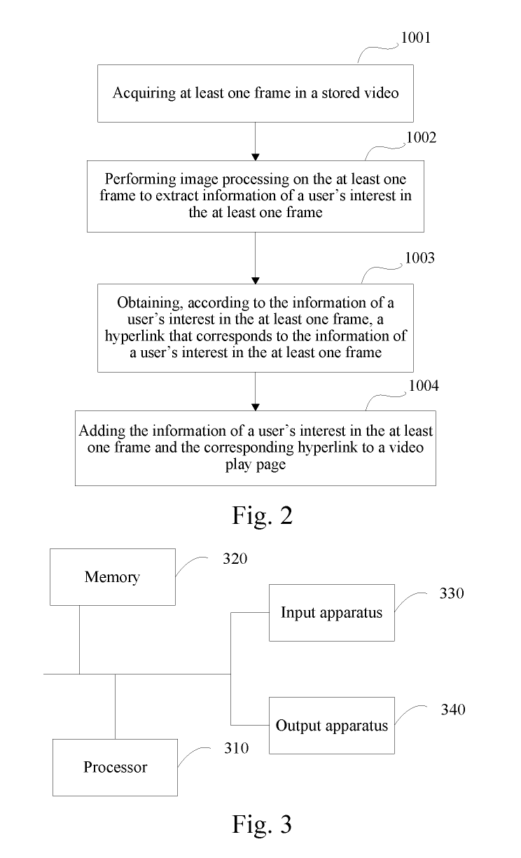

FIG. 2 is an exemplary flowchart of a method for creating a video image hyperlink according to an implementation manner of the present disclosure. As shown in FIG. 2, the method includes:

step 1001: acquiring at least one frame in a stored video;

step 1002: performing image processing on the at least one frame to extract information of a user's interest in the at least one frame;

step 1003: obtaining, according to the information of a user's interest in the at least one frame, a hyperlink that corresponds to the information of a user's interest in the at least one frame; and

step 1004: adding the information of a user's interest in the at least one frame and the corresponding hyperlink to a video play page.

In this embodiment, the acquiring at least one frame in a stored video includes: acquiring the at least one frame by means of an OpenGL.

In this embodiment, the method further includes: storing the video in a file format of m3u8.

In this embodiment, the information of a user's interest includes at least one of an article brand, an article price, an article name, an article introduction, a location name, a location introduction, a character name, or a personage introduction.

In this embodiment, the performing image processing on the at least one frame includes: performing ROI extraction on the at least one frame; performing gray processing on an image in the extracted ROI; and performing feature extraction on the gray processed image, so as to extract the information of a user's interest in the at least one frame.

It should be understood that the specific implementation manners of the foregoing method for creating a video image hyperlink are described in detail in the implementation manner of the exemplary server (as stated above), and details are not described herein again. In addition, a person skilled in the art may select any one of the foregoing implementation manners according to the present disclosure, or select a combination of the foregoing implementation manners to configure a server, and other alternate implementation manners also fall within the protection scope of the present disclosure.

The method and a server for creating a video image hyperlink provided in the present disclosure, enable a hyperlink to be created for information of a user's interest occurring in a video, that is, the information of a user's interest occurring in a video and the corresponding hyperlink can occur on a video play page, so that a user can conveniently and quickly enter a page relevant to the information of the user's interest (for example, an introduction page or a purchase page of the information of the user's interest) by clicking the hyperlink to learn further, thereby greatly improving user experience and satisfying a user's requirement.

The foregoing describes preferable implementation manners of the present disclosure in detail with reference to the accompanying drawings. However, the present disclosure is not limited to specific details in the foregoing implementation manners. Within a scope of technical concept of the present disclosure, multiple simple variations can be made to the technical solutions of the present disclosure, and these simple variations all belong to the protection scope of the present disclosure.

In addition, it should be noted that various specific technical features described in the foregoing specific implementation manners can be combined in any suitable manner without contradiction. To avoid unnecessary repetition, the present disclosure makes no other explanations about various possible combination manners.

In addition, various different implementation manners of the present disclosure can also be arbitrarily combined, as long as they do not depart from spirits of the present disclosure, and they should also be considered as content disclosed by the present disclosure.

1. A method for creating a video image hyperlink, wherein the method comprises:
acquiring at least one frame in a stored video;
performing image processing on the at least one frame to extract information of a user's interest in the at least one frame;
obtaining, according to the information of a user's interest in the at least one frame, a hyperlink that corresponds to the information of a user's interest in the at least one frame; and
adding the information of a user's interest in the at least one frame and the corresponding hyperlink to a video play page.

2. The method according to claim 1, wherein the acquiring at least one frame in a stored video comprises: acquiring the at least one frame by means of an open graphics library OpenGL.

3. The method according to claim 1, wherein the method further comprises:
storing the video in a file format of m3u8.

4. The method according to claim 1, wherein the information of a user's interest comprises at least one of an article brand, an article price, an article name, an article introduction, a location name, a location introduction, a character name, and a personage introduction.

5. The method according to claim 1, wherein the performing image processing on the at least one frame comprises:
performing a region-of-interest extraction on the at least one frame;
performing gray processing on an image in the extracted region-of-interest; and
performing feature extraction on the gray processed image to extract the information of a user's interest in the at least one frame.

6.-10. (canceled)

11. A non-volatile computer storage medium, which stores computer executable instructions, wherein the computer executable instructions are configured to:
acquire at least one frame in a stored video;
perform image processing on the at least one frame to extract information of a user's interest in the at least one frame;
obtain, according to the information of a user's interest in the at least one frame, a hyperlink that corresponds to the information of a user's interest in the at least one frame; and
add the information of a user's interest in the at least one frame and the corresponding hyperlink to a video play page.

12. The non-volatile computer storage medium according to claim 11, wherein the acquiring at least one frame in a stored video comprises: acquiring the at least one frame by means of an OpenGL.

13. The non-volatile computer storage medium according to claim 11, wherein the computer instructions are configured to:
store the video in a file format of m3u8.

14. The non-volatile computer storage medium according to claim 11, wherein the information of a user's interest comprises at least one of an article brand, an article price, an article name, an article introduction, a location name, a location introduction, a character name, and a personage introduction.

15. The non-volatile computer storage medium according to claim 11, wherein to perform image processing on the at least one frame the computer instructions are configured to:
perform region-of-interest extraction on the at least one frame;
perform gray processing on an image in the extracted region-of-interest; and
perform feature extraction on the gray processed image to extract the information of a user's interest in the at least one frame.

16. An electronic device, comprising:
at least one processor; and
a memory in communication connection with the at least one processor, wherein
the memory stores instructions that can be executed by the at least one processor, and execution of the instructions by the at least one processor cause the at least one processor to:
acquire at least one frame in a stored video;
perform image processing on the at least one frame to extract information of a user's interest in the at least one frame;
obtain, according to the information of a user's interest in the at least one frame, a hyperlink that corresponds to the information of a user's interest in the at least one frame; and
add the information of a user's interest in the at least one frame and the corresponding hyperlink to a video play page.

17. The electronic device according to claim 16, wherein to acquire at least one frame in a stored video the instructions causes the at least one processor to: acquire the at least one frame by means of an OpenGL.

18. The electronic device according to claim 16, wherein the instructions further cause the at least one processor to:
store the video in a file format of m3u8.

19. The electronic device according to claim 16, wherein the information of a user's interest comprises at least one of an article brand, an article price, an article name, an article introduction, a location name, a location introduction, a character name, or a personage introduction.

20. The electronic device according to claim 16, wherein to perform image processing on the at least one frame the instructions cause the at least one processor to:
perform a region-of-interest extraction on the at least one frame;
perform graying processing on an image in the extracted region-of-interest; and
perform feature extraction on the gray processed image to extract the information of a user's interest in the at least one frame.
